(19) United States
(12) Patent Application Publication
(10) Pub. No.: US 2010/0018393 A1
(43) Pub. Date: Jan. 28, 2010

(54) HUMIDIFICATION EXCHANGER WITH A CLEANING SYSTEM

(75) Inventor: Urs A. Weidmann, Zug (CH)

Correspondence Address: BROWDY AND NEIMARK, P.L.L.C.;624 NINTH STREET, NW, SUITE 300, WASHINGTON, DC, 20001-5303, US

(73) Assignee: Mentus Holding AG, Cham (CH)

(21) Appl. No.: 12/307,580

(22) PCT Filed: Jul. 1, 2007
(86) PCT No.: PCT/EP2007/056615

§ 371 Date: Jul. 1, 2009

(30) Foreign Application Priority Data
Jul. 3, 2006 (CH) 01068/06

(51) Int. Cl. B01D 65/02

(52) U.S. Cl. 95/52; 96/4

(57) ABSTRACT

A humidity exchanger for exchanging humidity between a first air stream and a second air stream contains a first cavity and a second cavity, which are separated by a structure permeable to water vapor, the first cavity configured to have the first air stream flow through it and a second cavity configured to have the second air stream flow through it. The humidity exchanger also contains a cleaning system having a cleaning module, which provides a liquid, vaporized, or gaseous cleaning fluid to clean the first cavity and/or the second cavity using the cleaning fluid. The cleaning may be supported using shockwaves, soundwaves, and/or ultrasound waves.

### CROSS REFERENCE TO RELATED APPLICATIONS

The present application is related to and claims priority of the PCT patent application number PCT/EP2007/056615 entitled Humidity exchanger with a cleaning system, filed on Jul. 1, 2007, the disclosure of which is herein incorporated by reference, which in turn claims priority of the Swiss patent application number 1068/06 filed Jul. 3, 2006.

### TECHNICAL FIELD OF THE INVENTION

The present invention relates to a humidity exchanger for exchanging humidity between two air streams, which has two cavities separated by a structure permeable to water vapor.

### PRIOR ART

A humidity exchanger for exchanging humidity between two air streams is known from U.S. Pat. No. 7,357,830. Such a humidity exchanger essentially comprises two cavities, which are separated by a structure permeable to water vapor. The structure permeable to water vapor separates the two air streams, but allows the exchange of humidity between the two air streams. The air stream to be dehumidified is guided through the first cavity and the air stream to be humidified is guided through the second cavity. The embodiment having two such humidity exchangers, which are connected to one another by a closed air circulation loop, is especially advantageous. The first air stream consists of outside air, which is to be supplied as processed supply air to a room, and a second air stream consists of return air, which is to be exhausted from the room and discharged to the surroundings as exhaust air, the humidity contained in the return air to be transferred to the supply air using one or two such humidity exchangers. Furthermore, cleaning such a humidity exchanger using water, the water being able to be heated using a heating element, is known from U.S. Pat. No. 7,357,830. The achievable degree of cleanness does not meet all practical demands, however.

A façade element for buildings, which contains an integrated humidity exchanger, is known from WO 9953245.

Diaphragms which are capable of separating water vapor and corresponding dehumidifying devices are known from U.S. Pat. No. 3,735,559.

Air streams which circulate in such humidity exchangers of the prior art often entrain particles, bacteria, and other undesired foreign materials. These foreign materials may accumulate in the cavities of the humidity exchangers and in the pores of the diaphragm. Such accumulations have a negative effect on the efficiency. In addition, the inflowing outside air is contaminated by the foreign materials.

### BRIEF DESCRIPTION OF THE INVENTION

The invention is based on the object of improving the cleaning of a humidity exchanger, which has two cavities separated by a structure permeable to water vapor, in such a way that a higher degree of cleanliness is achievable in the cavities. In particular, the cavities are to be able to be nearly or entirely sterilized.

This object is achieved by a humidity exchanger having a cleaning system.

A humidity exchanger for exchanging humidity between a first air stream and a second air stream contains two cavities separated by a structure permeable to water vapor, the first air stream flowing through the first cavity and the second air stream flowing through the second cavity. The humidity exchanger also contains a cleaning system, which comprises a cleaning module, at least one line system, and at least one pump. The cleaning module provides a cleaning fluid. The cleaning module is connected via the line system to the first cavity and/or the second cavity. The cleaning system comprises at least one pump to pump cleaning fluid out of the cleaning module into the first cavity and/or the second cavity and/or out of the cavities. Using the cleaning system, the first cavity and/or the second cavity and/or the structure permeable to water vapor may be efficiently cleaned in such a way that a higher degree of cleanliness is achieved.

The cleaning module may provide a gaseous or a liquid cleaning fluid. Pure water (H₂O) in the liquid aggregate state is not considered a cleaning fluid. In particular, hot steam is suitable as the cleaning fluid and the cleaning module is set up to generate hot steam in a preferred exemplary embodiment.

Furthermore, the cleaning module advantageously comprises an additive device, which is used to admix at least one liquid or gaseous additive to the cleaning fluid.

### BRIEF DESCRIPTION OF THE DRAWING

The invention is explained in greater detail hereafter on the basis of exemplary embodiments and on the basis of the drawing.

FIG. 1 shows a schematic view of an exemplary first humidity exchanger according to the prior art;

FIG. 2 shows a schematic view of the humidity exchanger of FIG. 1 having a cleaning system according to a first exemplary embodiment of the present invention;

FIG. 3 shows a schematic view of the device of FIG. 1 having a cleaning system according to a second exemplary embodiment of the present invention;

FIG. 4 shows a schematic view of an exemplary device having two humidity exchangers according to the prior art; and

FIG. 5 shows a schematic view of the device of FIG. 4 having a cleaning system according to a third exemplary embodiment according to the present invention.

### DETAILED DESCRIPTION OF THE INVENTION

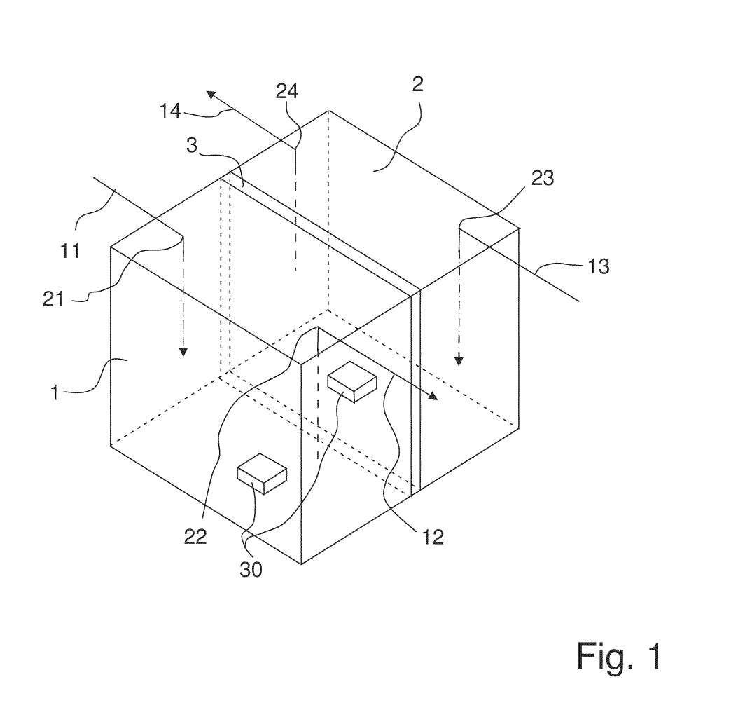

FIG. 1 shows a schematic perspective view of a humidity exchanger known from U.S. Pat. No. 7,357,830, for example. The humidity exchanger contains a first cavity 1 and a second cavity 2. The first cavity 1 is separated by a structure permeable to water vapor, for example, a diaphragm 3 permeable to water vapor, from the second cavity 2. In principle, any structure which permits water vapor to pass but blocks other gases and other molecules is usable. Such a structure may also be a porous rigid material. The first cavity 1 has a first air stream flowing through it, which enters as the first air stream 11 through an entry opening 21 into the cavity 1 and exits the cavity 1 through an exit opening 22 as the air stream 12, while the second cavity 2 has a second air stream flowing through it, which enters the cavity 1 through an entry opening 23 as the air stream 13 and exits the cavity 2 through an exit opening 24 as the air stream 14. The two cavities 1, 2 are preferably implemented in such a way that the air is guided meandering through the cavities 1 and/or 2 and the entry openings 21, 23 and the exit openings 22, 24 are situated on the top side of the humidity exchanger.

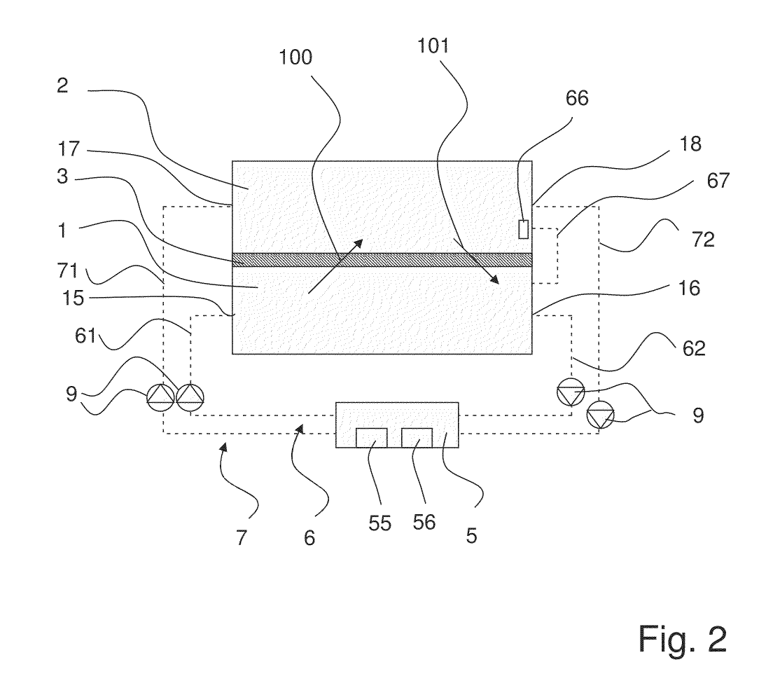

FIG. 2 schematically shows a top view of a first exemplary embodiment according to the present invention. The humidity exchanger comprises the first cavity 1, the second cavity 2, and a diaphragm 3 permeable to water vapor, which separates the first cavity 1 from the second cavity 2, as well as a cleaning system. The first cavity 1 has at least one inlet opening 15 and at least one outlet opening 16. The cleaning system comprises a cleaning module 5, line systems 6 and 7, and at least one pump 9. The line system 6 connects the cleaning module 5 to the first cavity 1. The line system 6 comprises a supply line 61, which connects the cleaning module 5 via the inlet opening 15 to the first cavity 1, and a drain line 62, which connects the first cavity 1 via the outlet opening 16 to the cleaning module 5. The second cavity 2 is connected similarly to the cleaning module 5. For this purpose, the line system 7 is provided, which comprises a supply line 71 and a drain line 72. The supply line 71 connects the cleaning module 5 via the inlet opening 17 to the second cavity 2. The drain line 72 connects the second cavity 2 via the outlet opening 18 to the cleaning module 5. The supply line 61 and the supply line 71 may be a shared line, which divides into two lines shortly before reaching the inlet openings 15, 17.

The cleaning module 5 is designed in such a way that it is capable of providing a cleaning fluid. Gaseous, vaporized, or liquid materials are suitable as the cleaning fluid. The cleaning fluid is used to clean the first cavity 1, the second cavity 2, and the diaphragm 3. During the cleaning of the cavities, the walls which delimit the cavities, and also other parts connected to the cavities 1, 2, such as valves, etc., are cleaned by the cleaning fluid. Cleaning of the diaphragm 3 is understood as both cleaning the surface of the diaphragm 3 and also cleaning its pores.

Hot steam is preferably used as the cleaning fluid. In this case, the cleaning module 5 is provided with a corresponding apparatus 55, which may generate hot steam. The apparatus 55 is a steam generator, for example. Using the hot steam, the cavities 1, 2 and the diaphragm 3 may be sterilized. The temperature of the hot steam is a function of the desired degree of sterilization. It is typically in the range from 100 to 120° C. The hot steam is under a certain pressure. The cavities 1, 2 and the diaphragm 3 are correspondingly implemented as pressure resistant.

Instead of hot steam, other fluids, such as organic or inorganic solvents, may also be used. Cleaning fluids which are based on soaps or suds are also possible. In addition, zeolite additives may be admixed. The cited fluids and also other arbitrary fluids may be mixed with one another. The cleaning module 5 therefore preferably contains an additive device 56, which may admix additives to the cleaning fluid. The additives may have a gaseous or liquid aggregate state. Only a single additive or an additive mixture comprising at least two additives may be admixed.

The cleaning system is additionally preferably equipped with a flushing device, so that after the cleaning procedure, it may flush at least the first cavity 1, through which the fresh outside air streams, which reaches the room in normal operation as supply air, during a specific period of time using outside air, without this air reaching the room. In the example, the flushing device comprises an armature 66 and a pipe section 67, which connects the first cavity 1 and the second cavity 2. The armature 66 is a flap, for example, which covers the outlet opening 22 in flushing operation and the entry to the pipe section 67 in normal operation. In flushing operation, the inflowing outside air reaches the cavity 1, flows through the cavity 1, is conducted at the exit of the cavity 1 into the cavity 2, flows through the cavity 2, and reaches the outside. In this way, unpleasant odors are removed from the cavities 1 and 2, without reaching the room to be supplied with supply air.

The cleaning may be mechanically supported with shockwaves, soundwaves, and/or ultrasound waves. An element 30 is provided for this purpose, which is capable of emitting energy, in particular longitudinally propagating waves. The element 30 is, for example, an ultrasonic generator, if the cleaning is to be supported using ultrasound. The element 30 is preferably situated on the floor of the cavity 1 and/or 2, whether inside or outside the cavity, so that the energy may be efficiently transmitted to the cleaning fluid even in the event of a low level of the cleaning fluid.

Pumps 9 for the circulation of the cleaning fluid may be situated both in the supply lines 61, 71 and also the drain lines 62, 72. In the present exemplary embodiment, one pump 9 is situated in each of the supply lines 61, 71 and of the drain lines 62, 72. The pumps 9 convey the cleaning fluid through the line system 6 and/or 7 and through the cavities 1, 2. If a shared supply line and a shared drain line are used, only one pump 9 needs to be situated in each of them.

If the pump 9 may convey the cleaning fluid in two directions, it is possible to remove contaminated cleaning fluid from the cavities 1, 2 again using the pump 9. The cleaning fluid is then supplied via the supply lines 61, 71 to the first cavity 1 and/or the second cavity 2 and also drained via the supply lines 61, 71. The drain lines 62, 72 are omitted in this case.

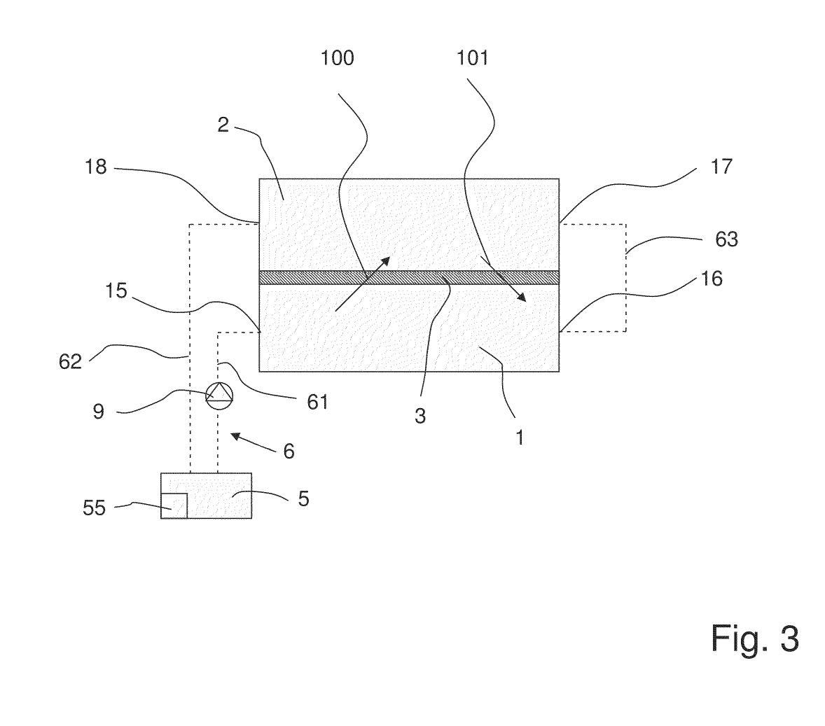

FIG. 3 shows a further exemplary embodiment according to the present invention, in which the cleaning fluid reaches the first cavity 1 via the first inlet opening 15 and exits the first cavity 1 again via the second outlet opening 16. A pipeline section 63 conducts the cleaning fluid via the inlet opening 17 into the second cavity 2. The cleaning fluid leaves the second cavity 2 again via the outlet opening 18. The cleaning fluid, as shown, may be supplied to the cleaning module 5, or alternatively drained in another way. It is also possible to have the cleaning fluid flow first through the second cavity 2 and then through the first cavity 1.

The humidity exchanger having the integrated cleaning system comprises a control unit which controls the operation. Various operating modes are possible for the cleaning of the cavities 1, 2, which may be applied both individually and also in combination. Five operating modes are explained hereafter.

### Operating Mode 1

The cleaning fluid is conveyed into the first cavity 1 and/or the second cavity 2. After passage of a certain application time, which may last from a few minutes to several hours, the contaminated cleaning fluid is conveyed back out of the first cavity 1 and/or the second cavity 2. If hot steam is used as the cleaning fluid, the application time is typically 10 to 25 minutes, but it may also be shorter or longer. In this operating mode, it is additionally possible to build up a pressure in the first cavity 1 and/or in the second cavity 2. The two cavities 1, 2 must be implemented as pressure-resistant in this case. This type of operation is particularly suitable for sterilization of the cavities 1, 2.

In the exemplary embodiment according to FIG. 2, the cleaning fluid is supplied via the supply lines 61, 71 to the first cavity 1 and/or the second cavity 2. During the application time, the cleaning fluid absorbs the contaminants accumulated in the two cavities 1, 2. Finally, the contaminated cleaning fluid is drained out of the two cavities 1, 2 via the outlet opening 16 or 18, respectively, and supplied back to the cleaning module 5 via the drain lines 62, 72.

### Operating Mode 2

In this operating mode, the cleaning fluid is continuously conveyed during a predetermined period of time through the first cavity 1 and/or the second cavity 2.

### Operating Mode 3

In this operating mode, the cleaning fluid is conveyed in brief pressure surges through the first cavity 1 and/or the second cavity 2.

### Operating Mode 4

This operating mode is only possible if hot steam is used as the cleaning fluid, because it is based on the permeability of the diaphragm 3 to water vapor. The hot steam is supplied via the supply line 61 to the first cavity 1, for example. The hot steam penetrates through the diaphragm 3, which is permeable to water vapor, and into the second cavity 2. This is illustrated in FIG. 2 by an arrow 100. The contaminated hot steam leaves the second cavity 2 again via the outlet opening 18.

Alternatively, it is possible to have the hot steam flow in the reverse direction from the second cavity 2 through the diaphragm 3, which is permeable to water vapor, into the first cavity 1, as illustrated in FIG. 2 by an arrow 101.

### Operating Mode 5

This operating mode is based on the operating mode 4. The hot steam is only permitted to flow into the cavity 1 in a first phase and the hot steam which has penetrated through the diaphragm 3 is removed from the cavity 2. In a second phase, fresh hot steam is only permitted to flow into the cavity 2, and the hot steam which has penetrated through the diaphragm 3 is removed from the cavity 1. In this operating mode, the pores of the diaphragm 3 are cleaned especially well.

For all operating modes, the possibility exists of supporting the cleaning with shockwaves, sound waves, or ultrasound.

The following is cited as an example of a possible combination of these operating modes. The cleaning is performed in a first phase according to the operating mode 1, in which the cleaning fluid is conveyed into the first cavity 1 and/or the second cavity 2 and is drained back out of the cavities after the application time. In a second phase, the cleaning is performed according to the operating mode 3, in which the cleaning fluid is conveyed through the cavities 1, 2 in one or more brief pressure surges.

The contaminated cleaning fluid is either disposed of by hand or discharged directly to the environment or recycled by the cleaning module 5. The cleaning module 5 is equipped with appropriate means for this purpose.

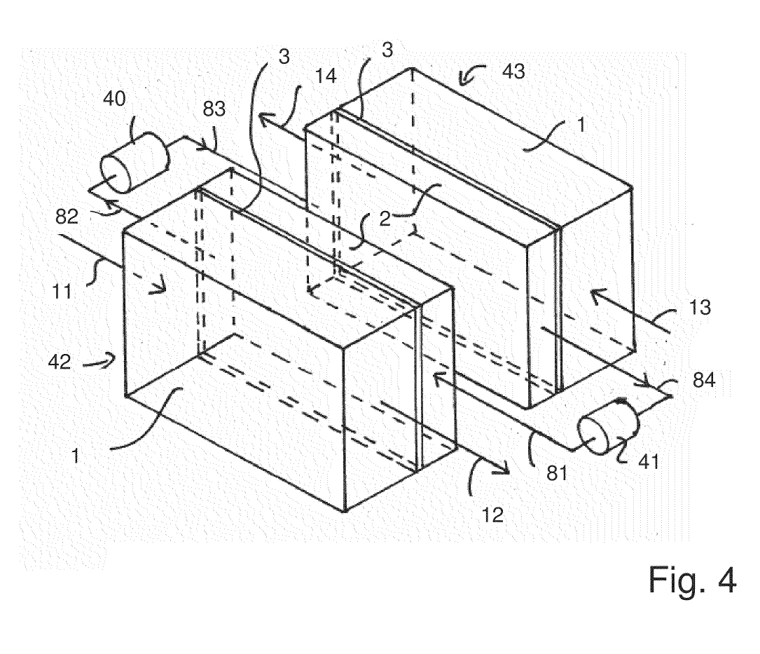

FIG. 4 schematically shows a device for the exchange of humidity between two air streams, which contains two humidity exchangers 42 and 43, which are connected to one another by a closed circulation loop. Such a device is known from U.S. Pat. No. 7,357,830.

Each humidity exchanger 42, 43 contains the two cavities 1 and 2. The cavity 2 of the first humidity exchanger 42 is connected via a closed air circulation loop to the cavity 1 of the second humidity exchanger 43. The closed air circulation loop comprises the air streams 81, 82, 83, and 84. Pumps or ventilators 40, 41 cause the air to circulate in the closed air circulation loop.

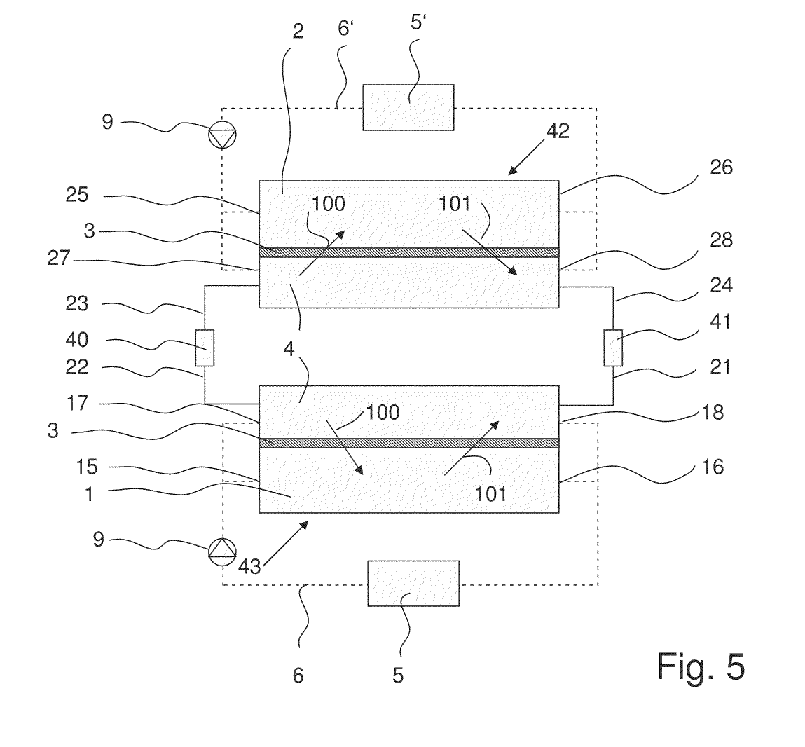

FIG. 5 shows the two humidity exchangers 42, 43 in a schematic view. A separate cleaning module 5 or 5′, respectively, is provided for each of the humidity exchangers 42, 43. The features of the cleaning systems and also their configuration are identical to those as were already explained on the basis of FIG. 2. The humidity exchangers 42, 43 may be cleaned using the cleaning systems in the way described above.

The two humidity exchangers 42, 43 preferably have a single, shared cleaning module 5. The line system is adapted accordingly.

A flushing device may also be provided in this exemplary embodiment to flush the cavities 1, 2 of the two humidity exchangers 42, 43 with outside air after the cleaning procedure.

The cleaning fluid may also be supplied to the corresponding cavities and/or the diaphragm via the existing air channels necessary for the operation of the humidity exchanger. This is possible, for example, if alcohol is used as the cleaning fluid.

The cited exemplary embodiments show that manifold guiding of the cleaning fluid is possible and that further variants and combinations are possible.

1-8. (canceled)

9. A humidity exchanger for exchanging humidity between a first air stream and a second air stream, comprising:
a first cavity configured to have the first air stream flow through the first cavity, a second cavity configured to have the second air stream flow through the second cavity, the first and second cavity separated by a structure permeable to water vapor, and
a cleaning system, the cleaning system comprising:
a cleaning module, which provides a cleaning fluid,
a line system, which connects the first cavity and/or the second cavity to the cleaning module, and
at least one pump to pump cleaning fluid out of the cleaning module into the first cavity and/or the second cavity or out of the cavities.

10. The humidity exchanger according to claim 9, the cleaning module comprising an apparatus for generating hot steam and providing the hot steam as the cleaning fluid.

11. The humidity exchanger according to claim 9, the cleaning module comprising an additive device, with which at least one liquid or gaseous substance may be admixed to the cleaning fluid.

12. The humidity exchanger according to claim 10, the cleaning module further comprising an additive device, with which at least one liquid or gaseous substance may be admixed to the cleaning fluid.

13. The humidity exchanger according to claim 9, further comprising an element for delivering shockwaves and/or soundwaves and/or ultrasound waves.

14. The humidity exchanger according to claim 10, further comprising an element for delivering shockwaves and/or soundwaves and/or ultrasound waves.

15. The humidity exchanger according to claim 11, further comprising an element for delivering shockwaves and/or soundwaves and/or ultrasound waves.

16. The humidity exchanger according to claim 12, further comprising an element for delivering shockwaves and/or soundwaves and/or ultrasound waves.

17. A method for cleaning a humidity exchanger having a first cavity and a second cavity, which are separated by a structure permeable to water vapor, the method comprising:
in a first step providing a cleaning fluid which is not pure water in the liquid aggregate state;
in a second step supplying the cleaning fluid to the first cavity, so that the cleaning fluid may perform the cleaning action; and
in a third step draining the cleaning fluid out of the first cavity.

18. The method according to claim 17, further comprising admixing an additive to the cleaning fluid after the first step.

19. The method according to claim 17, further comprising flushing the first cavity with outside air after the third step.

20. The method according to claim 18, further comprising flushing the first cavity with outside air after the third step.

21. A method for cleaning a humidity exchanger having a first cavity and a second cavity, which are separated by a structure permeable to water vapor, the method comprising:
in a first phase conveying hot steam into the first cavity and removing hot steam which has penetrated through the diaphragm from the second cavity, and
in a second phase conveying hot steam into the second cavity and removing hot steam which has penetrated through the diaphragm from the first cavity.
